(19) United States
(12) Patent Application Publication
(10) Pub. No.: US 2023/0412938 A1
(43) Pub. Date: Dec. 21, 2023

(54) SENSOR FAILURE DETECTION AND MITIGATION

(71) Applicant: Apple Inc., Cupertino, CA (US)

(72) Inventors: George E. WILLIAMS, Pleasanton, CA (US); Roddy M. SHULER, Palo Alto, CA (US)

(21) Appl. No.: 18/207,038

(22) Filed: Jun. 7, 2023

Related U.S. Application Data
(60) Provisional application No. 63/350,601, filed on Jun. 9, 2022.

(51) Int. Cl. H04N 25/61; H04N 23/66

(52) U.S. Cl. CPC H04N 25/61; G06T 7/0002; H04N 23/66

(57) ABSTRACT

The present disclosure generally relates to detecting and mitigating sensor failure. Such techniques optionally complement or replace other methods for detecting and mitigating sensor failure. Some techniques described herein cover a device detecting a sensor failure by identifying a mechanical object in a physical environment and determining that the mechanical object is capable of causing the sensor failure. The sensor failure is then mitigated by modifying an operation of the device. Other techniques described herein cover a device detecting a sensor failure by identifying a portion of the device in an image, identifying an expected characteristic of the portion, and determining that the portion does not currently include the expected characteristic. The sensor failure is then mitigated similarly to above by modifying an operation of the device.

### CROSS-REFERENCE TO RELATED APPLICATIONS

The present application claims benefit of U.S. Provisional Patent Application Ser. No. 63/350,601, entitled “SENSOR FAILURE DETECTION AND MITIGATION” filed on Jun. 9, 2022, which is hereby incorporated by reference in its entirety for all purposes.

### BACKGROUND

Devices often include sensors for capturing data with respect to their physical environment. Such data is prone to errors. Accordingly, there is a need to better detect and/or mitigate sensor failure to improve the data captured by the sensors.

### SUMMARY

Current techniques for detecting and mitigating sensor failure are generally ineffective, inefficient, and/or not sufficient for some applications. This disclosure provides more effective, efficient, and/or sufficient techniques for detecting and/or mitigating sensor failure. Such techniques optionally complement or replace other methods for detecting and mitigating sensor failure.

Some techniques described herein cover a device detecting a sensor failure by identifying a mechanical object in a physical environment and determining that the mechanical object is capable of causing the sensor failure. The sensor failure is then mitigated by modifying an operation of the device.

Other techniques described herein cover a device detecting a sensor failure by identifying a portion of the device in an image, identifying an expected characteristic of the portion, and determining that the portion does not currently include the expected characteristic. The sensor failure is then mitigated similarly to above by modifying an operation of the device.

The disclosure herein often describes a camera with lens flare as an example of a sensor failure. It should be understood that other types of sensors and other types of failures can be used with techniques described herein to improve current techniques.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating a graph application for detecting and mitigating lens flare.

FIG. 4 is a flow diagram illustrating a method for detecting and mitigating lens flare based on determining that a mechanical object is capable of causing lens flare.

FIG. 5 is a flow diagram illustrating a method for detecting and mitigating lens flare based on determining that a portion of a device does not include an expected characteristic.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

Some techniques described herein cover a device detecting a sensor failure (e.g., lens flare, veiling glare, occlusion, lidar impacted by sunlight, ultrasonic sensor impacted by wind noise or environmental noise, interference (e.g., lidar, radar, ultrasonic, or other sensor interfering with another sensor), hardware failure, software failure, or the like) by identifying a mechanical object in a physical environment and determining that the mechanical object is capable of causing the sensor failure. The sensor failure is then mitigated by modifying an operation of the device. In one example, a device including a camera identifies a mechanical object (e.g., an electrical or a non-organic object, such as a lamp) in an image captured by the camera. The device determines whether the mechanical object is capable of causing lens flare in an image (e.g., the same image that was used to identify the mechanical object) captured by the camera (e.g., the mechanical object is identified as a type of object that produces light). Based on determining that the mechanical object is capable of causing lens flare in an image captured by the camera, the device detects that lens flare is affecting an image captured by the camera. In some examples, the detecting is further based on identifying a characteristic indicative of lens flare in the image (e.g., a color, a shape, or a saturation of one or more pixels within the image). In response to the detecting, the device sends an instruction to modify an operation of the device to mitigate lens flare. In some examples, the instruction causes a component of the device (e.g., the entire camera, a part of the camera, or a covering of the camera) to be physically moved. In other examples, the instruction causes a component of the device to be modified, such as changing a suspension of the device or modifying a tint of a lens of the camera.

Other techniques described herein cover a device detecting a sensor failure by identifying a portion (e.g., a fiducial marker, such as an object placed in the field of view of an imaging system that appears in an image produced for use as a point of reference or a measure (in some examples, the portion may be a mark or a set of marks in the reticle of an optical instrument)) of the device in an image, identifying an expected characteristic of the portion, and determining that the portion does not currently include the expected characteristic. The sensor failure is then mitigated similarly to above by modifying an operation of the device. In one example, a device including a camera identifies the portion (e.g., a pattern printed on or extending from the device) in an image captured by the camera. The device then identifies an expected characteristic (e.g., a color or shape) of the portion. In some examples, the expected characteristic is identified using a record of expected characteristics of the portion. Based on determining that the portion does not include the expected characteristic (e.g., by analyzing a first image (e.g., the image) captured by the camera), the device detects that lens flare is affecting an image captured by the camera. In some examples, the detecting is further based on identifying a characteristic indicative of lens flare in the image. In response to the detecting, the device sends an instruction to modify an operation of the device to mitigate lens flare. In some examples, the instruction causes a component of the device to be physically moved. In other examples, the instruction causes a component of the device to be modified, such as changing a suspension of the device or modifying a tint of a lens of the camera.

In methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some examples, these terms are used to distinguish one element from another. For example, a first device could be termed a second device, and, similarly, a second device could be termed a first device, without departing from the scope of the various described embodiments. In some examples, the first device and the second device are two separate references to the same device. In some embodiments, the first device and the second device are both devices, but they are not the same device or the same type of device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

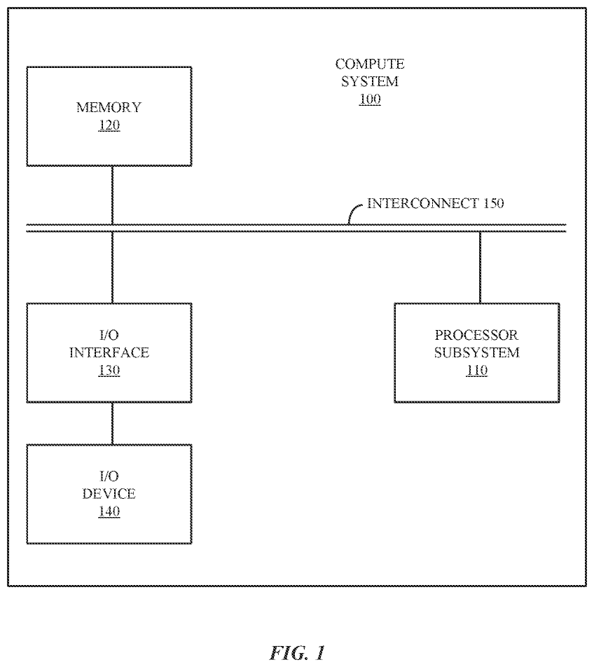

Turning now to FIG. 1, a block diagram of compute system 100 is depicted. Compute system 100 is a non-limiting example of a compute system that may be used to perform functionality described herein. It should be recognized that other computer architectures of a compute system may be used to perform functionality described herein.

In the illustrated example, compute system 100 includes processor subsystem 110 coupled (e.g., wired or wirelessly) to memory 120 (e.g., a system memory) and I/O interface 130 via interconnect 150 (e.g., a system bus, one or more memory locations, or other communication channel for connecting multiple components of compute system 100). In addition, I/O interface 130 is coupled (e.g., wired or wirelessly) to I/O device 140. In some examples, I/O interface 130 is included with I/O device 140 such that the two are a single component. It should be recognized that there may be one or more I/O interfaces, with each I/O interface coupled to one or more I/O devices. In some examples, multiple instances of processor subsystem 110 may be coupled to interconnect 150.

Compute system 100 may be any of various types of devices, including, but not limited to, a system on a chip, a server system, a personal computer system (e.g., an iPhone, iPad, or MacBook), a sensor, or the like. In some examples, compute system 100 is included with or coupled to a physical component for the purpose of modifying the physical component in response to an instruction (e.g., compute system 100 receives an instruction to modify a physical component and, in response to the instruction, causes the physical component to be modified (e.g., through an actuator)). Examples of such physical components include an acceleration control, a break, a gear box, a motor, a pump, a refrigeration system, a suspension system, a steering control, a vacuum system, a valve, a diffraction modifier (e.g., a focus mechanism), a heater, or the like. As used herein, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, a camera, an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. Although a single compute system is shown in FIG. 1, compute system 100 may also be implemented as two or more compute systems operating together.

In some examples, processor subsystem 110 includes one or more processors or processing units configured to execute program instructions to perform functionality described herein. For example, processor subsystem 110 may execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that are to be executed by processor subsystem 110. In such examples, the priority assigned to a task is used to identify a next task to execute. In some examples, the priority-based scheduler identifies a next task to execute when a previous task finishes executing (e.g., the highest priority task runs to completion unless another higher priority task is made ready).

In some examples, the middleware system provides one or more services and/or capabilities to applications (e.g., the one or more applications running on processor subsystem 110) outside of what is offered by the operating system (e.g., data management, application services, messaging, authentication, API management, or the like). In some examples, the middleware system is designed for a heterogeneous computer cluster, to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), ZeroMQ. In some examples, the middleware system represents processes and/or operations using a graph architecture, where processing takes place in nodes that may receive, post, and multiplex sensor data, control, state, planning, actuator, and other messages. In such examples, an application (e.g., an application executing on processor subsystem 110 as described above) may be defined using the graph architecture such that different operations of the application are included with different nodes in the graph architecture.

In some examples, a message sent from a first node in a graph architecture to a second node in the graph architecture is performed using a publish-subscribe model, where the first node publishes data on a channel in which the second node is able to subscribe. In such examples, the first node may store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

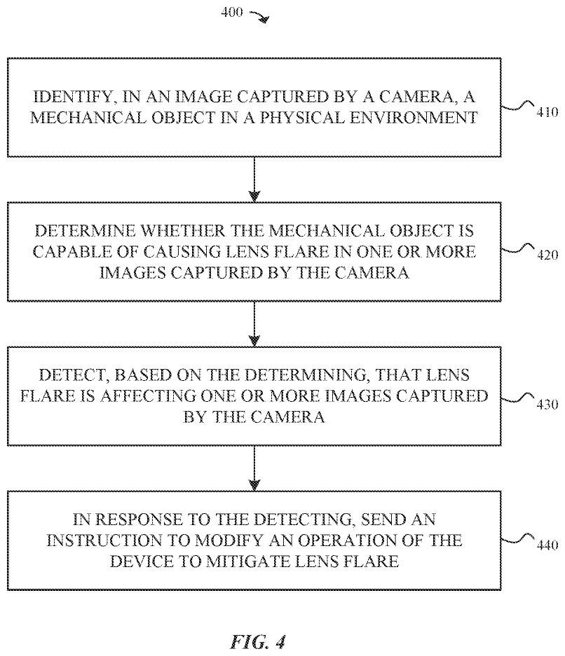

Memory 120 may include a computer readable medium (e.g., non-transitory or transitory computer readable medium) usable to store program instructions executable by processor subsystem 110 to cause compute system 100 to perform various operations described herein. For example, memory 120 may store program instructions to implement the functionality associated with the flow described in FIG. 4 and/or 5.

Memory 120 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Rather, compute system 100 may also include other forms of storage such as cache memory in processor subsystem 110 and secondary storage on I/O device 140 (e.g., a hard drive, storage array, etc.). In some examples, these other forms of storage may also store program instructions executable by processor subsystem 110 to perform operations described herein. In some examples, processor subsystem 110 (or each processor within processor subsystem 110) contains a cache or other form of on-board memory.

I/O interface 130 may be any of various types of interfaces configured to couple to and communicate with other devices. In some examples, I/O interface 130 includes a bridge chip (e.g., Southbridge) from a front-side bus to one or more back-side buses. I/O interface 130 may be coupled to one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is coupled to a network via a network interface device (e.g., configured to communicate over Wi-Fi, Bluetooth, Ethernet, or the like).

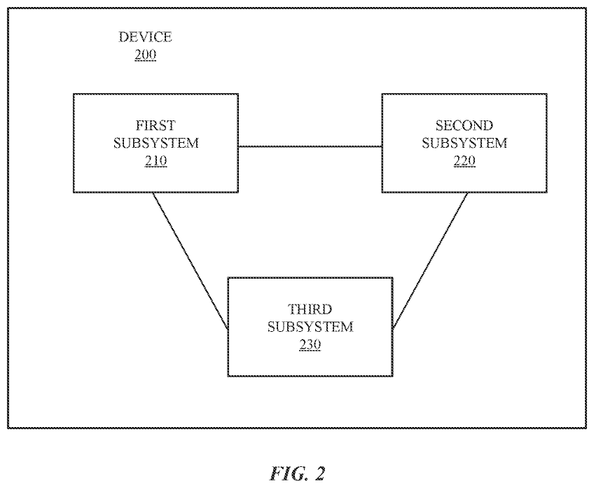

FIG. 2 depicts a block diagram of device 200 with interconnected subsystems. In the illustrated example, device 200 includes three different subsystems (i.e., first subsystem 210, second subsystem 220, and third subsystem 230) coupled (e.g., wired or wirelessly) to each other. An example of a possible computer architecture of a subsystem as included in FIG. 2 is described in FIG. 1 (i.e., compute system 100). Although three subsystems are shown in FIG. 2, device 200 may include more or fewer subsystems.

In some examples, some subsystems are not connected to another subsystem (e.g., first subsystem 210 may be connected to second subsystem 220 and third subsystem 230 but second subsystem 220 may not be connected to third subsystem 230). In some examples, some subsystems are connected via one or more wires while other subsystems are wirelessly connected. In some examples, one or more subsystems are wirelessly connected to one or more compute systems outside of device 200, such as a server system. In such examples, the subsystem may be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), a vehicle, or the like. In some examples, device 200 is configured to navigate device 200 (with or without direct user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 may each be a camera that is capturing images for third subsystem 230 to use to make a decision. In some examples, at least a portion of device 200 functions as a distributed compute system. For example, a task may be split into different portions, where a first portion is executed by first subsystem 210 and a second portion is executed by second subsystem 220.

Attention is now directed towards detection and mitigation techniques using an example of a camera and lens flare. It should be understood that other types of sensors and other types of sensor failures are within scope of this disclosure and may benefit from techniques described herein.

Lens flare, in some examples, occurs when light is scattered or flared in a lens system of a camera, often in response to a bright light, producing an artifact in an image captured by the camera. This may happen through light scattered by the lens system itself, for example through internal reflection and forward scatter from parts in the lens system. In addition, lens systems with large numbers of elements tend to have more lens flare as they contain a relatively large number of interfaces at which internal scattering may occur.

Lens flare is often a transitory effect. It is therefore advantageous to be able to detect when lens flare occurs and mitigate after it has been detected. According to examples described herein, a device may detect that lens flare is affecting a camera (e.g., a camera of the device or a camera of another device communicating with the device) and cause an operation to be performed to mitigate.

One technique for detecting lens flare includes identifying an object in a physical environment proximate to a camera. In some examples, identifying the object includes using one or more images captured by the camera, data captured by a different sensor (e.g., a different camera or a different type of sensor), a message indicating an identification of the object (e.g., received from the object through a wireless communication or received from a process that identifies objects in a physical environment), a predefined map including the object (e.g., comparing a location and/or orientation of the object with a location and/or orientation of the object within the predefined map), or any combination thereof.

In some examples, the identifying includes locating the object in the physical environment. Such locating may occur without classifying the object such that location, orientation, and/or movement information is determined for the object but a type of the object is not determined. A person of ordinary skill in the art should understand that there are a number of different ways to locate an object in a physical environment (sometimes referred to as object localization), including Viola-Jones object detection, bag of features model, or histogram of orientated gradients feature extraction. In some examples, the identifying includes classifying the object (e.g., identifying a type of the object). For example, an object in a physical environment may be identified as a lamp or flashlight. A person of ordinary skill in the art should understand that there are a number of different ways to classify an object in a physical environment (sometimes referred to as object detection), including using non-neural approaches (e.g., Supported Vector Machine or AdaBoost) or neural network approaches (e.g., regions with convolutional neural network or You only look once (YOLO) model).

After identifying the object, the technique may include determining whether the object is capable of causing lens flare. In some examples, such determining is performed in a region determined to include the object. For example, the region may be searched to identify an output device capable of producing light. For another example, the region (or a nearby region proximate to the region) may be searched to identify an effect of light (e.g., a pattern in image indicative of light). In such an example, light may be identified coming from the object without identifying an output device capable of producing light. In some examples, determining whether the object is capable of causing lens flare includes determining whether the type of object includes an output device capable of producing light. In such examples, such determining is performed without using an image and instead using a record with data characterizing the type of object. In some examples, the record is obtained by requesting such information from a remote device. In other examples, the record is included in a database stored by the device that is determining whether the object is capable of causing lens flare.

In some examples, determining whether the object is capable of causing lens flare includes determining an orientation of the object (or an orientation of an output device of the object) and an orientation of the camera. In such examples, determining includes determining that the orientations of the object and the camera are consistent with the object producing light that is capable of causing lens flare in one or more images captured by the camera.

In some examples, the object identified in the physical environment is a mechanical object that includes an artificial light source, such as a light bulb in a lamp. In such examples, the object may be tracked at an object level to determine when the object capable of causing lens flare as either the camera and/or the object moves over time.

After determining that the object is capable of causing lens flare, the technique may include detecting that lens flare is affecting one or more images captured by the camera. In some examples, the determination that the object is capable of causing lens flare is used as the sole factor for detecting lens flare. In other examples, the determination that the object is capable of causing lens flare is used to increase a confidence level that lens flare is affecting a camera. In some examples, the determining that the object is capable of causing lens flare is one factor amongst other factors to detect that lens flare is affecting one or more images captured by the camera. Additional factors may include a time of day (e.g., lens flare may be more likely to occur at different times of the day), a current weather (e.g., lens flare may be more likely to occur with certain weather), a determination that lens flare is no longer affecting the camera (e.g., that lens flare is no longer there, potentially because the object is no longer in the presence of the camera), a determination that lens flare is affecting the camera differently (e.g., an artifact of lens flare has moved location), or the like. In some examples, at least one additional factor is received as input from a remote device separate from a device including the camera (e.g., a current weather is provided by a remote device). In some examples, all factors to detect that lens flare is affecting an image captured by the camera is received as input from a subsystem of the device including the camera.

A person of ordinary skill in the art should understand that there are a number of different techniques for detecting lens flare that may be used together with the technique described above as one or more additional factors, including a circular detector (e.g., such as through Hough-transform), a SIFT detector, a blob detector, capturing images at different exposures, tracking artifact movement over different images, or the like. In some examples, one factor may use computer vision or machine learning to identify one or more characteristics of lens flare in an image. In such examples, the one or more characteristics may correspond to color, shape, and/or saturation in pixels of the image that are indicative of lens flare. In some examples, known lens flare patterns are identified in one or more pixels in the image to detect that lens flare is affecting the image. Examples of known lens flare patterns include particular color patterns around edges of lens flare effects, particular color channels saturating before other color channels, a cluster of pixels with particular color that is either consistent with lens flare or different from surrounding pixels, fully/partial circular disks included in an image, and fully/partial halos included in an image. It should be recognized that there are other known lens flare patterns and that the list above is merely provided as an example. In some examples, the computer vision or machine learning technique is tuned to a specific camera, such that the pattern matching is identifying known lens flare patterns for a particular lens, a particular lens system, a particular camera, or a particular type of camera.

Another technique for detecting lens flare includes identifying a portion of a device in an image captured by a camera of the device. In some examples, identifying the portion includes locating an area of the device that was predefined before capturing the image, such as an area that is expected to have one or more particular characteristics. In some examples, the portion of the device is not predefined before capturing the image and the identifying includes establishing the portion of the device to be used in further steps for this technique. In some examples, identifying the portion includes locating the portion in the image similarly to as described above for locating an object.

In some examples, the portion includes a printed pattern on the device (e.g., a QR code or some other pattern), a physical component of the device (e.g., a physical component extending from the device in a field of view of the camera), or some other identifiable portion (e.g., a portion having a particular set of one more colors and/or a particular shape) of the device.

After identifying the portion, the technique may include determining one or more expected characteristics of the portion. In some examples, an expected characteristic is identified from a record of one or more characteristics of the portion. The record may be included on a device making the determination or stored on a remote device such that a request for an expected characteristic is sent to the remote device. In such examples, the record may be created based on one or more images from the camera or one or more images from a different camera. In some examples, the record is created based on one or more images captured by a second camera included on a different device from the device that includes the camera used to capture the image. In some examples, one or more expected characteristics are identified in the image such that a future image may be analyzed to see whether an expected characteristic (e.g., at least one of the one or more expected characteristics or all of the one or more expected characteristics) is still present. Examples of an expected characteristic include shape and color of the portion.

After determining the expected characteristic of the portion, the technique may include determining whether the portion includes the expected characteristic. In some examples, the determining is based on an image captured by the camera (e.g., the image discussed above in which the portion is identified or another image captured after the first image). Based on determining that the portion does not include the expected characteristic, the technique includes detecting that lens flare is affecting an image of the camera (e.g., because lens flare is hiding or changing the color of the expected characteristic). Based on determining that the portion does include the expected characteristic, the technique includes detecting that lens flare is not affecting an image of the camera (e.g., because lens flare is not hiding or changing the color of the expected characteristic).

In some examples, the determination that the portion does include the expected characteristic is used as the sole factor for detecting lens flare. In other examples, the determination the portion does include the expected characteristic is used to increase a confidence level that lens flare is affecting a camera. In some examples, the determining that the portion does not include the expected characteristic is one factor amongst other factors to detect that lens flare is affecting one or more images captured by the camera. Additional factors may include a time of day (e.g., lens flare may be more likely to occur at different times of the day), a current weather (e.g., lens flare may be more likely to occur with certain weather), a determination that lens flare is no longer affecting the camera (e.g., that lens flare is no longer there, potentially because the object is no longer in the presence of the camera), a determination that lens flare is affecting the camera differently (e.g., an artifact of lens flare has moved location), or the like. In some examples, at least one additional factor is received as input from a remote device separate from a device including the camera (e.g., a current weather is provided by a remote device). In some examples, all factors to detect that lens flare is affecting an image captured by the camera is received as input from a subsystem of the device including the camera. Also similar to as described above, a person of ordinary skill in the art should understand that there are a number of different techniques for detecting lens flare that may be used together with the technique described here as one or more additional factors.

After detecting that lens flare is affecting one or more images captured by the camera according to any of the techniques described herein, some techniques may attempt to mitigate. In some examples, mitigating is based on a type of sensor failure detected. For example, a first mitigation technique may be performed when a first type of sensor failure is detected and a second mitigation technique may be performed when a second type of sensor failure is detected.

In some techniques, a device selects a mitigation technique from multiple possible mitigation techniques. In some examples, the mitigation techniques selected is based on a likelihood (or confidence level) that a particular sensor failure is occurring, whether a previous mitigation technique was successful, a time of day, a current weather, a current moving context of the device (e.g., a speed or acceleration of the device), a location or orientation of the device (e.g., relative to a physical environment proximate to the device), missing information in a particular area of the physical environment for which the device is attempting to make a decision, information about objects in a physical environment (e.g., location, orientation, or status of objects or portions of objects), or the like. In some examples, different levels of confidence correspond to different mitigation techniques, such that certain mitigation techniques are only performed when a confidence level exceeds a threshold.

In some examples, a mitigation technique includes actuating (e.g., moving) the device, a subsystem of the device (e.g., the camera or any subsystem described in FIG. 2), or a part of a subsystem of the device (e.g., a hood, a lens, or an image sensor of the camera). For example, the device may be caused to move in a particular pattern, such as moving sideways so that the camera is facing a different direction or in a path that allows the camera to capture some images without being affected be lens flare. For another example, the device may be configured to take a first path before lens flare is detected and, in response to detecting lens flare, change the first path to a second path to attempt to mitigate lens flare. For another example, a suspension of the device may be modified (e.g., to change a yaw or a pitch of the camera). For another example, a camera may include an electronic neutral density filter configured to change a tint of a lens of the camera (in some examples, the electronic neutral density filter is configured to change a tint for a first portion of the lens and not a second portion of the lens). For another example, an image sensor of the camera may be translated to remove or move lens flare in an image outside of an area needed for a current determination. In some examples, a mitigating technique blocks a part of a field of view of the camera that is not needed for a current determination. In some examples, a mitigation technique includes switching to a different camera of the device and using one or more images of the different camera to make a decision. In some examples, a mitigation technique includes switching to a different type of sensor (other than the camera) when the different type of sensor is able to capture information needed for a particular decision. In some examples, a mitigation technique includes doing nothing because the camera that is affected by lens flare is not needed at the time. In some examples, different mitigation techniques are maintained for different amounts of time before reversing the mitigation technique.

In some examples, reducing an effect of lens flare may be accomplished by having multiple cameras of a device capturing images of a particular area. For example, a device may be configured to have multiple cameras that are orientated in different directions with at least partial overlapping fields of view for the particular area. The different directions allow light to be received by each camera slightly differently, potentially allowing for one camera to be affected be lens flare and another to not be affected by lens flare. In some examples, the multiple cameras are attached to the device in such a way as to always be oriented in different directions. In other examples, at least one of the cameras is configured to be actuated (e.g., moved) to cause the cameras to have different orientations. In such examples, a check for whether actuation is needed may occur at different times, such as at the beginning of navigation of a device or after one or more of the cameras are moved. In some examples, cameras are moved to have the same orientation for a particular purpose and then moved to have different orientations after the particular purpose is accomplished (e.g., calculating a depth of a location).

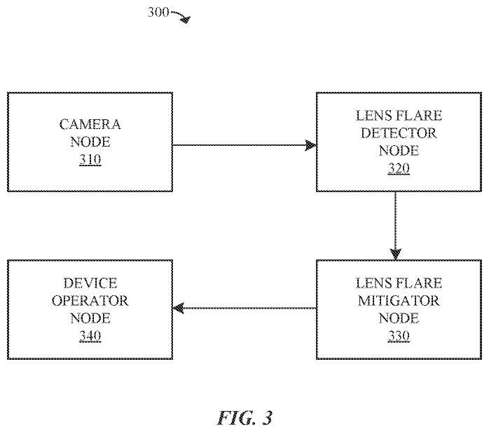

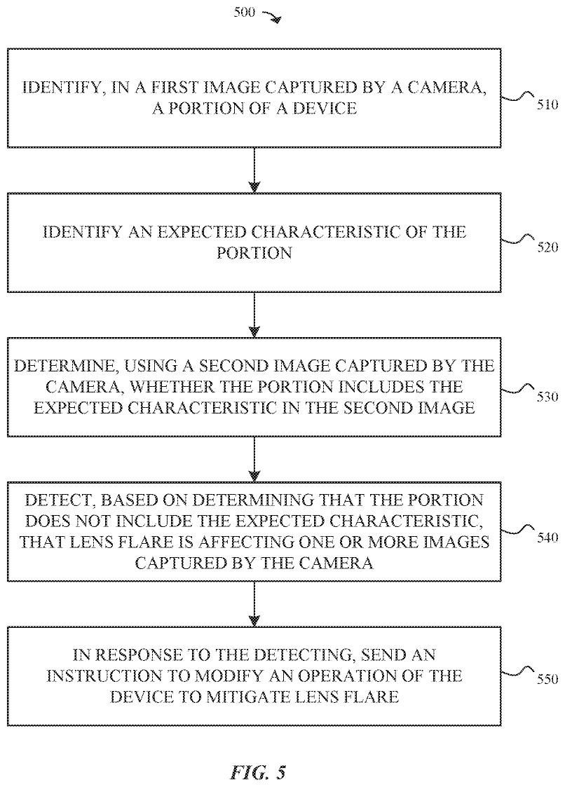

FIG. 3 is a block diagram illustrating graph application 300 for detecting and mitigating lens flare, in accordance with some examples. This figure is used to illustrate a software architecture for executing the techniques described above or processes described below, including the process in FIG. 4 and the process in FIG. 5. In some examples, graph application 300 is an example of an application executing on processor subsystem 110 as described in FIG. 1. While FIG. 3 relates to detecting lens flare in an image captured by a camera, it should be understood that other types of sensors and other types of failures can be used with techniques described herein.

Graph application 300 includes four nodes: camera node 310, lens flare detector node 320, lens flare mitigator node 330, and device operator node 340. Each node in graph application 300 represents functionality performed to detect and mitigate lens flare. For example: camera node 310 includes one or more operations performed by a camera of a device; lens flare detector node 320 includes one or more operations performed to detect whether lens flare is detected in an image captured by the camera; lens flare mitigator node 330 includes one or more operations performed to determine how to mitigate lens flares; and device operator node 340 includes one or more operations for controlling operation of the device.

It should be recognized that more or fewer nodes could be used for the functionality described herein. For example, graph application 300 may include multiple instances of camera node 310, a different instance for each camera of the device. In such an example, lens flare detector node 320 may receive data from each of the multiple instance of camera node 310 (e.g., data from different cameras). For another example, graph application 300 may include one or more different types of sensor nodes for capturing different types of sensor data and sending the sensor data to lens flare detector 320 (e.g., a radar sensor node may include one or more operations performed by a radar sensor of the device). For another example, graph application 300 may include a device node for maintaining speed, location, orientation, and other information about the state of the device. In such an example, the device node may send data to different nodes of graph application 300, including lens flare detector node 320, lens flare mitigator node 330, and device operator node 340. For another example, graph application 300 may include a navigation node for determining a path for a device to take in a physical environment. In such an example, the navigation node may determine that information is needed in a particular area of the physical environment and send a request for this information to lens flare mitigator node 330 to use to determine how best to mitigate lens flare to obtain information in the particular area. For another example, graph application 300 may include a perception node for identifying information about objects in a physical environment (e.g., location, orientation, or status of objects or portions of objects). In such an example, the perception node may send data to different nodes of graph application 300, including lens flare detector node 320 and lens flare mitigator node 330. For another example, graph application 300 may include multiple types of device operator node 340, a different type for each different subsystem of the device that may be instructed to perform an operation to mitigate lens flare. In such an example, each different type of device operator node 340 may receive data from lens flare mitigator node 330 to identify when to perform a respective operation.

In FIG. 3, the nodes in graph application 300 are connected with edges, each edge representing data that is provided from one node to another. For example, camera node 310 is connected to lens flare detector node 320 with an edge, indicating that data is provided from camera node 310 to lens flare detector node 320. Data can be provided from one node to another in a number of ways. For example, camera node 310 may send a message with data to lens flare detector node 320. For another example, camera node 310 may store data in a memory location accessible by lens flare detector node 320 and notify lens flare detector node 320 that the data has been stored in the memory location. In such an example, lens flare detector node 320 may access the memory location to obtain the data after being notified by camera node 310. An example of such data is an image captured by a camera corresponding to camera node 310. Another example of such data is configuration data for the camera, to be used by lens flare detector node 320 to identify information about the camera such as its orientation and lens flare mitigator node 330 to identify information which mitigation techniques are available for the camera.

In some examples, lens flare detector node 320 provides an indication of whether lens flare is detected in an image of a particular camera and, optionally, a confidence level that lens flare was detected to lens flare mitigator node 330. In some examples, lens flare mitigator node 330 receives one or more other inputs, such as a time of day, a current weather, or other inputs described herein. In some examples, lens flare mitigator node 330 uses the indication, the confidence level, and/or the one or more other inputs to determine a mitigation technique to perform. In such examples, lens flare mitigator node 330 sends a message indicating the determined mitigation technique to device operator node 340, instructing device operator node 340 to modify an operation of the device.

FIG. 4 is a flow diagram illustrating method 400 for detecting and mitigating lens flare based on determining that a mechanical object is capable of causing lens flare. Some operations in method 400 are, optionally, combined, the orders of some operations are, optionally, changed, and some operations are, optionally, omitted.

In some examples, method 400 is performed at a compute system (e.g., compute system 100) that is in communication with a camera. In some examples, the compute system and the camera are included in a device (e.g., device 200). In some examples, the device includes one or more actuators and/or one or more sensors other than the camera. In some examples, the camera is connected via at least one or more wires to the one or more processors of the device; in some examples, the camera is wirelessly connected to the one or more processors of the device; in some examples, the one or more processors are included in a component of the device separate from the camera; in some examples, the one or more processors are included in the camera; in some examples, a plurality of processors of a device perform the method, where at least one step is performed by one or more processors on a first system on a chip (i.e., SoC) and a second step is performed by a second SoC, and where the first SoC and the second SoC are distributed in different locations on the device, where the different locations are separated by at least 12 inches.

At 410, method 400 includes identifying, in an image (e.g., a representation of a physical environment) (in some examples, the image includes one or more color channels, such as red, green, and blue or an amount of light) captured by the camera (in some examples, the image has been processed after being captured and before the mechanical object has been identified (e.g., processing can include enhancing or otherwise modifying the image data captured by the camera)), a mechanical object (e.g., a non-organic object) (in some examples, the mechanical object is configured such that it can produce light at times and not produce light at other times) (in some examples, the mechanical object includes an electrical circuit) in a physical environment. In some examples, the image is captured by a camera associated with camera node 310 of FIG. 3. In such examples, lens flare detector node 320 performs 410.

At 420, method 400 includes determining (in some examples, the determining is performed by a processor of the camera; in some examples, the determining is performed by a processor remote from the camera; in some examples, the determined is performed using computer vision and/or machine learning) whether the mechanical object is capable of causing lens flare in one or more images captured by the camera (in some examples, the determining includes determining that the mechanical object is currently producing light in a direction of the camera) (in some examples, the determining does not include determining whether the mechanical object is currently producing light; in some examples, the determining does not include whether the mechanical object is producing light in a direction of the camera and/or the device, just that the mechanical object is producing light). In some examples, determining whether the mechanical object is capable of causing lens flare in one or more images captured by the camera includes determining whether the mechanical object is currently producing light (in some examples, determining whether the mechanical object is currently producing light include identifying a characteristic of light in one or more images). In some examples, lens flare detector node 320 of FIG. 3 performs 420.

At 430, method 400 includes detecting, based on determining that the mechanical object is capable of causing lens flare in one or more images captured by the camera, that lens flare is affecting one or more images captured by the camera (in some examples, the detecting is further based on identifying a characteristic of lens flare in a captured image (e.g., the image) that is indicative of lens flare (e.g., color, shape, or saturation of one or more pixels within the captured image). In some examples, detecting that lens flare is affecting one or more images captured by the camera is further based on a current time of day (in some examples, further based on daylight hours or a time of sunrise and/or sunset; in some examples, the current time of day is an hour, minute, second, any combination thereof, or the like; in some examples, the current time of day is a classification, such as morning, evening, night, or the like). In some examples, detecting that lens flare is affecting one or more images captured by the camera is further based on an identification of a current weather state (in some examples, the current weather state includes whether it is sunny, cloudy, foggy, rainy, snowy, thunder storming, smoggy, or any combination thereof). In some examples, detecting that lens flare is affecting one or more images captured by the camera is further based on an orientation of the mechanical object (in some examples, further based on an orientation of the camera and not the orientation of the mechanical object; in some examples, further based on an orientation of the camera, such that the detecting is based on the orientation of the camera relative to the orientation of the mechanical object). In some examples, lens flare detector node 320 of FIG. 3 performs 430.

At 440, method 400 includes, in response to the detecting, sending an instruction to modify an operation of the device to mitigate lens flare. In some examples. sending the instruction causes a tint of a lens of the camera to be modified (in some examples, the tint is modified such that light is not able to pass through the lens in a particular area; in some examples, when an instruction causes the tint of the lens of the camera to be changed, there is not an instruction sent to cause any movement of any component of the device to mitigate lens flare). In some examples, lens flare detector node 320 of FIG. 3 performs 440, such that the instruction of 440 is sent to device operator node 340 of FIG. 3.

In some examples, method 400 further includes identifying (in some examples, the identifying is performed using computer vision or machine learning), in a first image (in some examples, the first image is captured by the camera) at a first location, a visual characteristic of lens flare. In some examples, method 400 further includes identifying (in some examples, the identifying is performed using computer vision or machine learning), in a second image (in some examples, the second image is captured by the camera) at a second location, a lack of a visual characteristic of lens flare (e.g., lens flare is not identified or identified in a different location in a later captured image), wherein: the second location corresponds to the first location (in some examples, the second location is determined to be the same location as the first location; in some examples, the second location is the first location), the second image is captured after the first image, and detecting that lens flare is affecting one or more images captured by the camera is further based on identifying a visual characteristic of lens flare in the first image at the first location and identifying a lack of a visual characteristic of lens flare in the second image at the second location (in some examples, a visual characteristic of lens flare is identified at a third location in the second image, wherein the third location is different from the first location; in some examples, a visual characteristic of the lens flare is not identified in the second image).

In some examples, method 400 further includes, in response to detecting that lens flare is affecting one or more images captured by the camera, publishing, via a first channel, a message that indicates lens flare is affecting one or more images captured by the camera, wherein a first logical node of the device performs the detecting that lens flare is affecting one or more images captured by the camera (in some examples, the first channel includes a queue in which messages are stored and accessible by one or more other nodes). In some examples, method 400 further includes, by a second logical node of the device, wherein the second logical node is different from the first logical node: receiving, via the first channel, the message (in some examples, the second logical node received the message by accessing a queue associated with the first channel in which the messages is stored within; in some examples, the second logical node receives the message after (1) receiving a notification that the message is accessible via the first channel and (2) sending a request to access the message); and performing, based on the message, an operation related to navigating the device (in some examples, performing the operation includes causing the device to move in a different direction; in some examples, performing the operation includes changing a path for which the device is taking such that a future movement of the device is changed). In some examples. sending the instruction causes a planned route for the device to be changed from a first route to a second route, and wherein the second route is different from the first route.

In some examples, method 400 further includes selecting a mitigation movement from a plurality of potential mitigation movements, wherein sending the instruction causes the mitigation movement to be performed (in some examples, the plurality of potential mitigation movements include different types of movements, such as moving the device, moving a component of the camera, changing a camera for which used to navigate, or the like). In some examples, selecting the mitigation movement includes selecting a physical component of the device from a plurality physical components of the device (in some examples, different types of physical components of the device include the entire device, a camera of the device, a component of a camera of the device, a lens shade or hood of a camera of the device, a suspension of the device, or any combination thereof). In some examples, selecting the mitigation movement includes selecting a type of movement from a plurality of different types of movements (in some examples, different types of movements include zoom, pan, tilt, dolly, truck, pedestal, rack focus, or any combination thereof). In some examples, selecting the mitigation movement is based on an operational mode (e.g., manual mode or autonomous mode) of the device. In some examples, selecting the mitigation movement is based a driving characteristic (e.g., speed, turning, stopped, parked, or reversing) of the device. In some examples, selecting the mitigation movement is based on a determined activity of an object (in some examples, the object is a person, a mechanical device different (e.g., separate from) the device, or an organic object in a physical environment) identified by a camera of the device.

Note that details of the processes described above with respect to method 400 (i.e., FIG. 4) are also applicable in an analogous manner to the method described below. For example, method 500 of FIG. 5 optionally includes one or more of the characteristics of the various methods described above with reference to method 400. For example, detecting that lens flare is affecting one or more images captured by the camera can be based on both (1) determining that the portion of the object does not include the expected characteristic, from method 500, and (2) determining that the mechanical object is capable of causing lens flare in one or more images captured by the camera, from method 400. For brevity, these details are not repeated below.

FIG. 5 is a flow diagram illustrating method 500 for detecting and mitigating lens flare based on determining that a portion of a device does not include an expected characteristic. Some operations in method 500 are, optionally, combined, the orders of some operations are, optionally, changed, and some operations are, optionally, omitted.

In some examples, method 500 is performed at compute system (e.g., compute system 100) that is in communication with a camera. In some examples, the compute system and the camera are included in a device (e.g., device 200). In some examples, the device includes one or more actuators and/or one or more sensors other than the camera. In some examples, the camera is connected via at least one or more wires to the one or more processors of the device; in some examples, the camera is wirelessly connected to the one or more processors of the device; in some examples, the one or more processors are included in a component of the device separate from the camera; in some examples, the one or more processors are included in the camera; in some examples, a plurality of processors of a device perform the method, where at least one step is performed by one or more processors on a first system on a chip (i.e., SoC) and a second step is performed by a second SoC, and where the first SoC and the second SoC are distributed in different locations on the device, where the different locations are separated by at least 12 inches.

At 510, method 500 includes identifying (in some examples, identifying is locating or categorizing), in a first image (e.g., a representation of a physical environment) (in some examples, the image includes one or more color channels, such as red, green, and blue or an amount of light) captured by the camera (in some examples, the image has been processed after being captured and before the portion of the device has been identified (e.g., processing can include enhancing or otherwise modifying the image data captured by the camera)), a portion of the device. In some examples, the portion includes a pattern printed on the device (in some examples, the portion is a QR code). In some examples, the portion extends from a surface of the device (in some examples, the portion extends from a housing of the device). In some examples, the image is captured by a camera associated with camera node 310 of FIG. 3. In such examples, lens flare detector node 320 performs 510.

At 520, method 500 includes identifying an expected characteristic (e.g., an expected physical characteristic) (in some examples, the expected characteristic includes color and/or shape) of the portion (in some examples, identifying the expected characteristic is performed using a record of expected characteristics of the portion; in some examples, the identifying is performed without using the first image; in some examples, the expected characteristic was known to the device before capturing the first image; in some examples, the identifying is performed based on identifying which part of the portion of the device is or should be included in the first image). In some examples, the expected characteristic includes a particular shape. In some examples, the expected characteristic includes a particular color (in some examples, one or more particular colors). In some examples, the expected characteristic is identified (1) using an image captured from a second camera different from the camera, (2) based on a third image captured by the camera, wherein the third image is captured by the camera before the second image (in some examples, also before the first image), or (3) based on information predefined before capturing the first image (in some examples, the information is not captured by a camera of the device). In some examples, lens flare detector node 320 performs 520.

At 530, method 500 includes determining (in some examples, the determining is performed by a processor of the camera; in some examples, the determining is performed by a processor remote from the camera; in some examples, the determined is performed using computer vision and/or machine learning), using a second image (in some examples, the second image is the first image; in some examples, the second image is captured at a time after the first image is captured) captured by the camera, whether the portion includes the expected characteristic in the second image. In some examples, the second image is the first image. In some examples, lens flare detector node 320 performs 530.

At 540, method 500 includes detecting, based on determining that the portion does not include the expected characteristic, that lens flare is affecting one or more images captured by the camera (in some examples, the detecting is further based on identifying a characteristic of lens flare in a captured image (e.g., the image) that is indicative of lens flare (e.g., color, shape, or saturation of one or more pixels within the captured image). In some examples, lens flare detector node 320 performs 540.

At 550, method 500 includes, in response to the detecting, sending an instruction to modify an operation of the device to mitigate lens flare. In some examples, sending the instruction causes a tint of a lens of the camera to be modified (in some examples, the tint is modified such that light is not able to pass through the lens in a particular area; in some examples, when an instruction causes the tint of the lens of the camera to be changed, there is not an instruction sent to cause any movement of any component of the device to mitigate lens flare). In some examples, lens flare detector node 320 of FIG. 3 performs 550, such that the instruction of 550 is sent to device operator node 340 of FIG. 3.

In some examples, method 500 further includes selecting a mitigation movement from a plurality of potential mitigation movements, wherein sending the instruction causes the mitigation movement to be performed (in some examples, the plurality of potential mitigation movements include different types of movements, such as moving the device, moving a component of the camera, changing a camera for which used to navigate, or the like). In some examples, selecting the mitigation movement includes selecting a physical component of the device from a plurality physical components of the device (in some examples, different types of physical components of the device include the entire device, a camera of the device, a component of a camera of the device, a lens shade or hood of a camera of the device, a suspension of the device, or any combination thereof). In some examples, selecting the mitigation movement includes selecting a type of movement from a plurality of different types of movements (in some examples, different types of movements include zoom, pan, tilt, dolly, truck, pedestal, rack focus, or any combination thereof). In some examples, selecting the mitigation movement is based on an operational mode (e.g., manual mode or autonomous mode) of the device. In some examples, selecting the mitigation movement is based a driving characteristic (e.g., speed, turning, stopped, parked, or reversing) of the device. In some examples, selecting the mitigation movement is based on a determined activity of an object (in some examples, the object is a person, a mechanical device different (e.g., separate from) the device, or an organic object in a physical environment) identified by a camera of the device.

Note that details of the processes described above with respect to method 500 (i.e., FIG. 5) are also applicable in an analogous manner to method 400 of FIG. 4. For example, method 400 optionally includes one or more of the characteristics of the various methods described above with reference to method 500. For example, method 500 may be a first step that is performed to detect that lens flare is likely affecting an image of a camera and method 400 may be a second step that is performed after the first step to confirm that lens flare is affecting an image of the camera.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the detection and/or mitigation of sensor failure. The present disclosure contemplates that in some instances, this gathered data may include personal information data that uniquely identifies or can be used to identify a specific person and/or a specific location. Such personal information data can include an image of a person, an image of data related to a person, an image of a location, or any other identifying or personal information.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. In addition, policies and practices should be adapted for the particular types of personal information data being collected and/or accessed and adapted to applicable laws and standards, including jurisdiction-specific considerations. Hence different privacy practices may be maintained for different personal data types in each country.

Moreover, it is the intent of the present disclosure that personal information data should be managed and handled in a way to minimize risks of unintentional or unauthorized access or use. Risk can be minimized by limiting the collection of data and deleting data once it is no longer needed.

What is claimed is:

1. A method for detecting and mitigating lens flare, the method comprising:
at a device including a camera:
identifying, in an image captured by the camera, a mechanical object in a physical environment;
determining whether the mechanical object is capable of causing lens flare in one or more images captured by the camera;
detecting, based on determining that the mechanical object is capable of causing lens flare in one or more images captured by the camera, that lens flare is affecting one or more images captured by the camera; and
in response to the detecting, sending an instruction to modify an operation of the device to mitigate lens flare.

2. The method of claim 1, wherein determining whether the mechanical object is capable of causing lens flare in one or more images captured by the camera includes determining whether the mechanical object is currently producing light.

3. The method of claim 1, wherein detecting that lens flare is affecting one or more images captured by the camera is further based on a current time of day.

4. The method of claim 1, wherein detecting that lens flare is affecting one or more images captured by the camera is further based on an identification of a current weather state.

5. The method of claim 1, wherein detecting that lens flare is affecting one or more images captured by the camera is further based on an orientation of the mechanical object.

6. The method of claim 1, further comprising:
identifying, in a first image at a first location, a visual characteristic of lens flare; and
identifying, in a second image at a second location, a lack of a visual characteristic of lens flare, wherein:
the second location corresponds to the first location,
the second image is captured after the first image, and
detecting that lens flare is affecting one or more images captured by the camera is further based on identifying a visual characteristic of lens flare in the first image at the first location and identifying a lack of a visual characteristic of lens flare in the second image at the second location.

7. The method of claim 1, further comprising:
in response to detecting that lens flare is affecting one or more images captured by the camera, publishing, via a first channel, a message that indicates lens flare is affecting one or more images captured by the camera, wherein a first logical node of the device performs the detecting that lens flare is affecting one or more images captured by the camera; and
by a second logical node of the device, wherein the second logical node is different from the first logical node:
receiving, via the first channel, the message; and
performing, based on the message, an operation related to navigating the device.

8. The method of claim 7, wherein sending the instruction causes a planned route for the device to be changed from a first route to a second route, and wherein the second route is different from the first route.

9. The method of claim 1, wherein sending the instruction causes a tint of a lens of the camera to be modified.

10. The method of claim 1, further comprising:
selecting a mitigation movement from a plurality of potential mitigation movements, wherein sending the instruction causes the mitigation movement to be performed.

11. The method of claim 10, wherein selecting the mitigation movement includes selecting a physical component of the device from a plurality of physical components of the device.

12. The method of claim 10, wherein selecting the mitigation movement includes selecting a type of movement from a plurality of different types of movements.

13. The method of claim 10, wherein selecting the mitigation movement is based on an operational mode of the device.

14. The method of claim 10, wherein selecting the mitigation movement is based a driving characteristic of the device.

15. The method of claim 10, wherein selecting the mitigation movement is based on a determined activity of an object identified by a camera of the device.

16. A non-transitory computer-readable storage medium storing one or more programs configured to be executed by one or more processors of a device, the one or more programs including instructions for:
identifying, in an image captured by a camera, a mechanical object in a physical environment;
determining whether the mechanical object is capable of causing lens flare in one or more images captured by the camera;
detecting, based on determining that the mechanical object is capable of causing lens flare in one or more images captured by the camera, that lens flare is affecting one or more images captured by the camera; and
in response to the detecting, sending an instruction to modify an operation of the device to mitigate lens flare.

17. A device, the device comprising:
a camera;
one or more processors; and
memory storing one or more programs configured to be executed by the one or more processors, the one or more programs including instructions for:
identifying, in an image captured by a camera, a mechanical object in a physical environment;
determining whether the mechanical object is capable of causing lens flare in one or more images captured by the camera;
detecting, based on determining that the mechanical object is capable of causing lens flare in one or more images captured by the camera, that lens flare is affecting one or more images captured by the camera; and
in response to the detecting, sending an instruction to modify an operation of the device to mitigate lens flare.
